(19) United States
(12) Patent Application Publication
(10) Pub. No.: US 2013/0239382 A1
(43) Pub. Date: Sep. 19, 2013

(54) JOINT OF CRIB AND METHOD FOR LOCKING AND RELEASING THE JOINT

(71) Applicant: PAO-HSIEN CHENG, TAINAN (TW)

(72) Inventor: PAO-HSIEN CHENG, TAINAN (TW)

(21) Appl. No.: 13/423,626

(22) Filed: Mar. 19, 2012

(51) Int. Cl. F16B 12/40; B23P 11/00

(52) U.S. Cl. 29/426.1; 403/33

(57) ABSTRACT

The present invention relates to a joint of a crib and a method for releasing the joint. A flexible linkage unit is connected between the joints so that when one of the joints is released, the other joints are released by the linkage unit simultaneously. The top frame of the crib is able to be folded easily. The one action folding feature allows the user to fold the crib by one hand and hold the kid by the other hand.

### BACKGROUND OF THE INVENTION

1. Field of the Invention

The present invention relates to a joint of a crib and a method for locking and releasing the joint, and more particularly, to a join which is easily released to release all of the joints of the crib simultaneously.

2. Description of Related Art

Taiwan Patent Publication No. M382780 discloses joints respectively connected between the side tubes of the top frame of a crib and the top frame of the crib can be folded by operation of the joints.

Taiwan Patent Publication No. M345539 and M323250 respectively disclose a joint that is similar to Taiwan Patent Publication No. M382780, and provide joints for connecting the side tubes of the top frame, and the top frame is folded by operation of the joints.

However, when folding the top frame, the joints have to be released one by one, that is to say, the user cannot release all the joints by releasing one of the joints.

Besides, Taiwan Patent Publication No. M375912 discloses a joint of a crib and the joint has a pressing member which is pressed when releasing the joint. The pressing member is moved to push the support members on two sides thereof so as to rotate the support members which then do not support the support members and the crib can be folded. However, it is experienced that the pressing action to the pressing member may not successfully rotate the support members as expected and the joint cannot be released.

The present invention intends to provide a joint for a crib and all of the joints of the crib can be released by simply releasing one of the joints.

### SUMMARY OF THE INVENTION

The present invention relates to a joint of a crib which has two joints connected to a top frame thereof. The joint comprises a mounting member, two operation units, a resilient member and two end pieces. The mounting member has a bridge and two side plates extend from two ends of the bridge so as to define a space between the two side plates. The two operation units are pivotably connected to each other and located in the space of the mounting member and the two operation units are pivotably connected to the two side plates. The mounting member are connected to two side tubes of the top frame and two end pieces are respectively engaged with two respective distal ends of the two side tubes of the top frame. When the operation unit of one of the two joints is pushed and the side tube corresponding to the operation unit is rotated about to the extreme position, the end piece of the side tube is hooked with the operation unit and drives the other operation unit on the other end of the joint to force the two operation units not to support the side tubes of the top frame. The joints are then released.

The primary object of the present invention is to provide a joint of a crib and one of the joints is released, the rest of the joints of the top frame are released simultaneously.

Another object of the present invention is to provide a joint of a crib wherein the once the joint is released from one end thereof, the other end of the joint is ensured to be released to avoid the user from folding the top frame by force while the other end of the joint is still in locked status.

The present invention relates to a method for releasing the joint. A flexible linkage unit is connected between the joints so that when one of the joints is released, the other joints are released by the linkage unit simultaneously. The top frame of the crib is able to be folded easily. The one action folding feature allows the user to fold the crib by one hand and hold the kid by the other hand.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the frame of the crib of the present invention;

FIG. 2 is to an exploded view show the joint of the present invention;

FIG. 3 shows the joint designated by circle A of FIG. 1 of the present invention;

FIG. 4 shows that the joint designated by circle A of FIG. 1 of the present invention is pushed;

FIG. 5 shows the action of the joint designated by circle B of FIG. 1 of the present invention;

FIG. 6 shows the other action of the joint designated by circle B of FIG. 1 of the present invention;

FIG. 7 shows the crib of the present invention with the joints cooperated with the casings;

FIG. 8 is an exploded view to show the joint cooperated with the casings, and

FIG. 9 is an exploded view to show the bottom base of the crib of the present invention.

### DETAILED DESCRIPTION OF THE PREFERRED EMBODIMENT

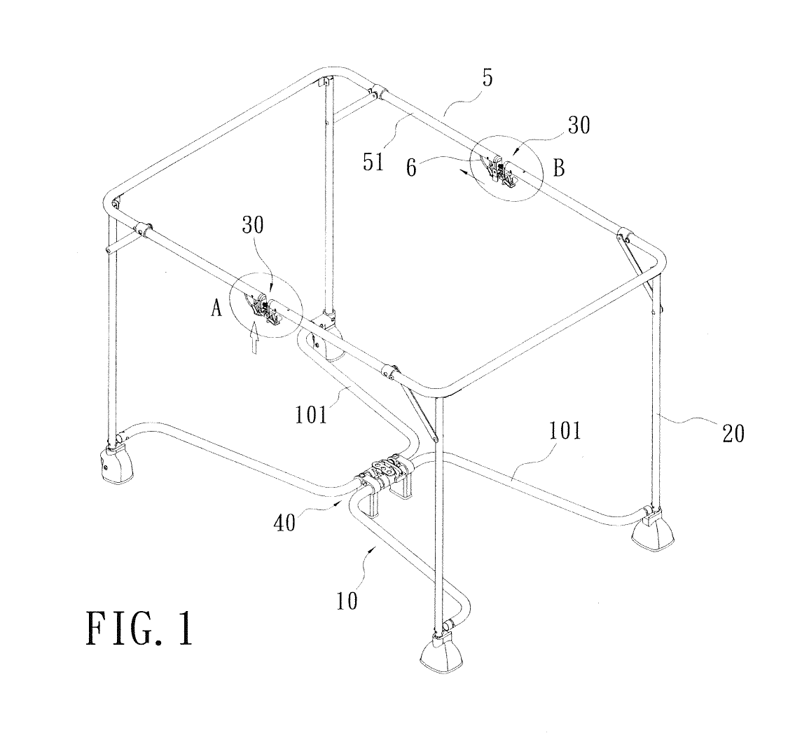

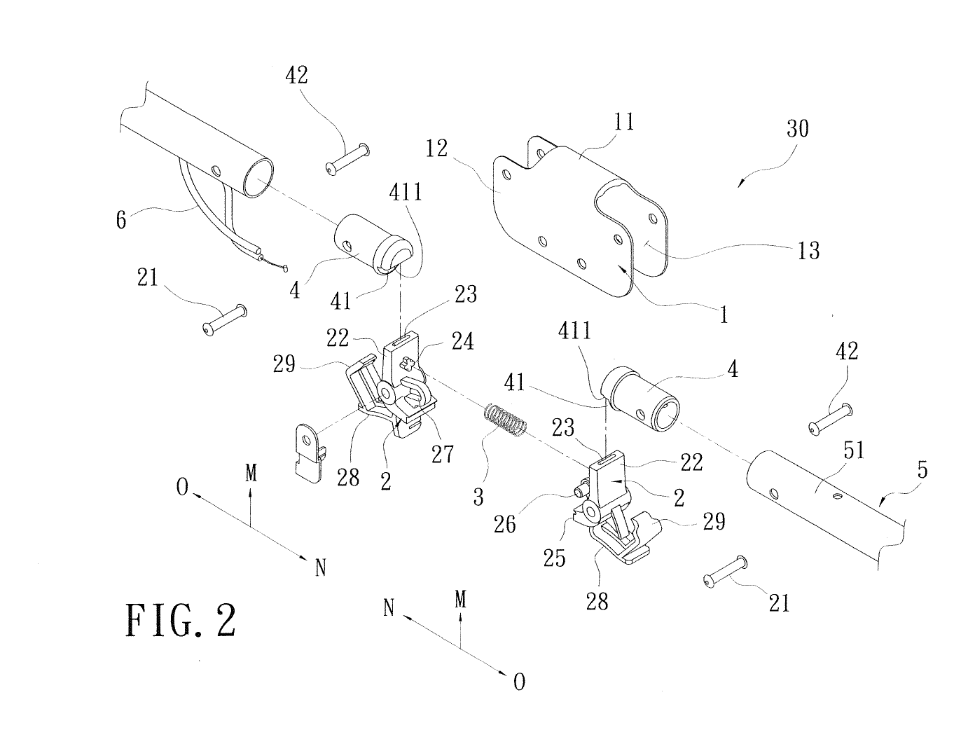

Referring to FIGS. 1 and 2, the frame of the crib of the present invention comprises a top frame 5, a bottom frame 10 and four upright members 20. The top frame 5 has at least two joints 30 and the four upright members 20 are connected to the four corers of the top frame 5. Each upright member 20 is connected to the bottom frame 10 by its lower end. The distal ends of the links 101 of the bottom frame 10 are connected to a bottom base 40.

The joint 30 comprises a mounting member 1, two operation units 2, a resilient member 3 and two end pieces 4.

The mounting member 1 has a bridge 11 and two side plates 12 extend downward from two ends of the bridge 11. A space 13 defined between the two side plates 12.

The two operation units 2 are located in the space 13 of the mounting member 1 and each operation unit 2 is pivotably connected between the two side plates 12 by a first pin 21. Each operation unit 2 has a support piece 22 extending toward a first direction M (toward the top frame). Each of the support pieces 22 has an engaging member 23 protruding from the top thereof. Each of the support pieces 22 has a contact member 25 extends toward a second direction N. The support piece 22 is connected to the contact member 25. One of the two operation units 2 has a pivot 26 on the top of the contact member 25 and the other one of the two operation units 2 has an elongate hole 27 defined in the top of the contact member 25. The pivot 26 is engaged with the elongate hole 27. Each of the two operation units 2 has a pressing section 28 extending toward a third direction O (the direction away from each other).

The resilient member 3 connected between the engaging members 24 of the two operation units 2.

The two end pieces 4 are respectively engaged with two respective distal ends of the two side tubes 51 of the top frame 5. Each end piece 4 having a notch 41 which is located corresponding to the support piece 22 of the operation unit 2 corresponding thereto. Each of the end pieces 4 has a groove 411 located beside the notch 41, the engaging member 23 is engaged with the groove 411. A second pin 42 extends through the side plates 12, the side tube 51 and the end piece 4 to pivotably connect the mounting member 1 to the side tubes 51. The end pieces 4 are secured in the side tubes 51.

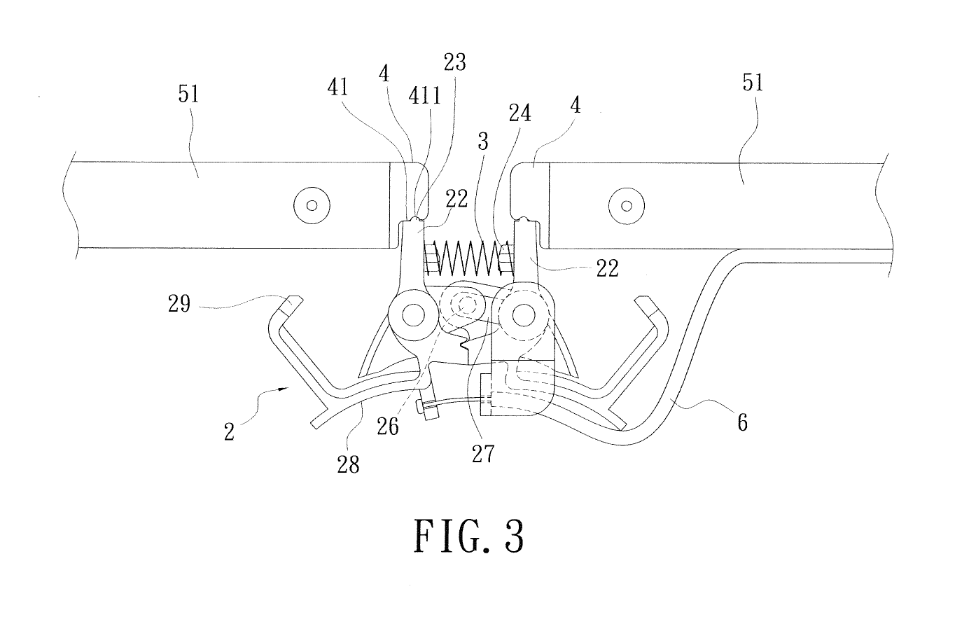

A linkage unit 6 is connected between the two joints 30, as shown in FIGS. 3 to 5, the linkage unit 6 is a flexible unit, preferably, the linkage unit 6 is a cable. The linkage unit 6 has a first end connected to the pressing section 28 of one of the operation units 2 of one of the two joints 30, a second end of the linkage unit 6 is connected to the pressing section 28 of one of the operation units 2 of the other one of the two joints 30.

When expanding the crib, the side tubes 51 are located horizontally so that the notch 41 of each of the end pieces 4 is supported by the support piece 22 of the operation unit 2. The resilient member 3 biases the two operation units 2, and the two contact members 25 of the two operation units 2 are in contact with each other. Therefore, the two operation units 2 are firmly in contact with each other to ensure that the top frame does not fold unexpectedly.

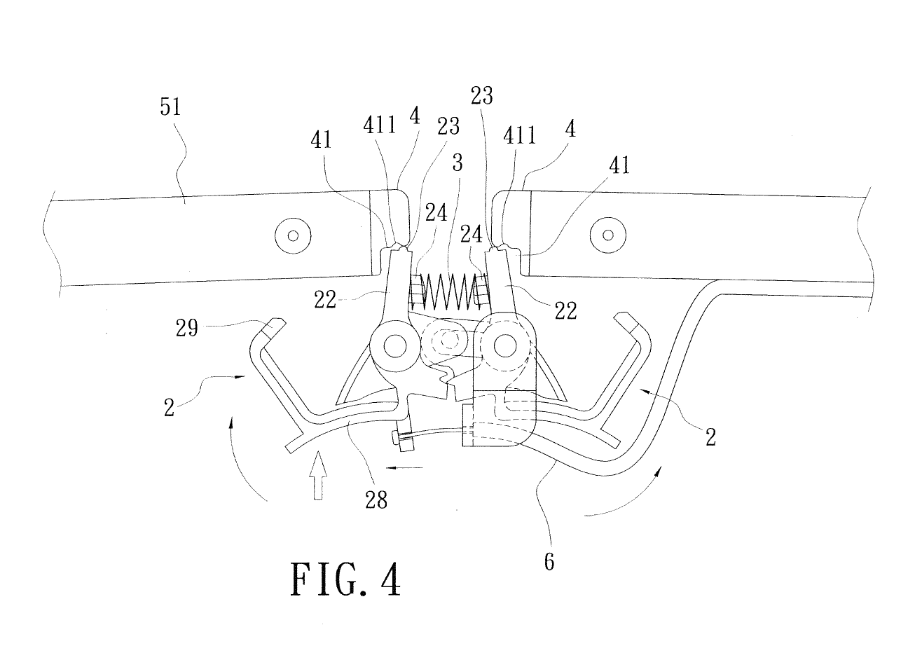

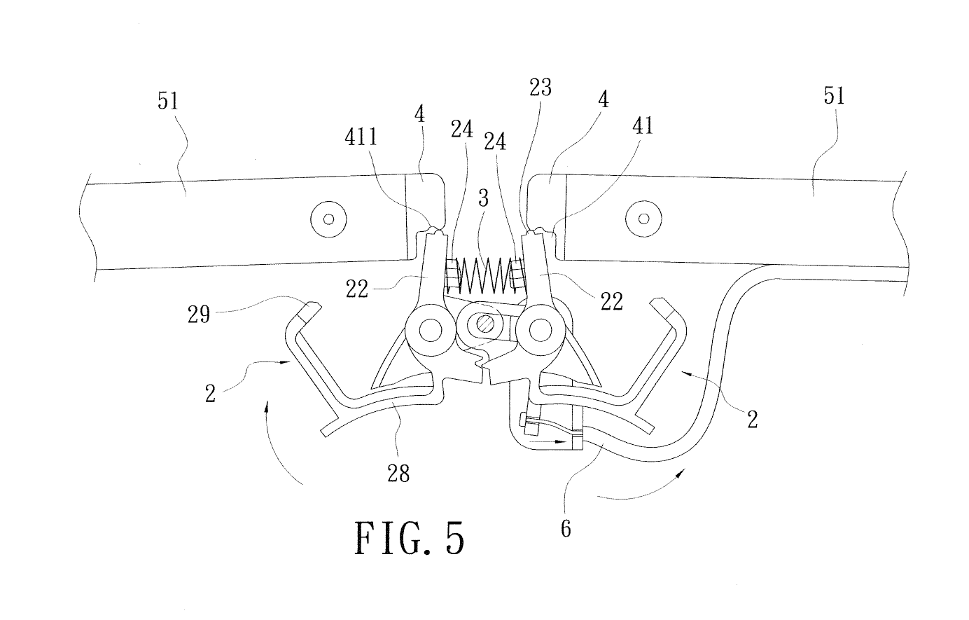

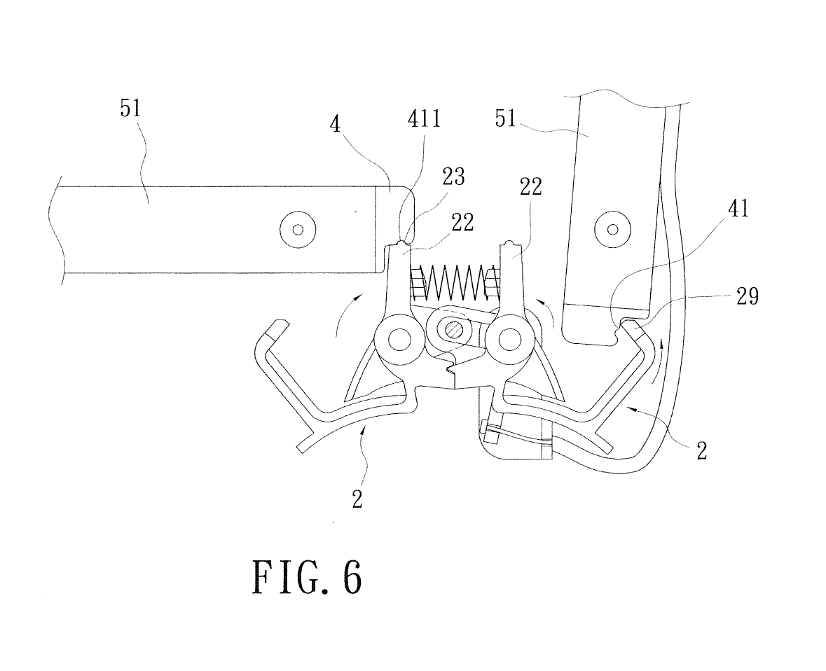

Further referring to FIGS. 3 and 4, when folding the top frame 5, the user pushes the pressing section 28 of one of the operation units 2 of one of the joints 30, the linkage unit 6 drives the operation unit 2 of the other joint 30 as shown in FIGS. 5 and 6, to let the two operation units 2 of the two joins 30 not support the side tubes 51. Therefore, when one joint 30 is released, by the linkage unit 6, the rest of the joint 30 is released, this allows the user to fold the crib by one hand and hold the kid by the other hand.

When the pressing section 28 of one of the operation units 2 is pushed, the operation unit 2 is pivoted about the first pin 21 and toward the first direction M, in the meanwhile, because the contact members 25 of the two operation units 2 are in contact with each other, the other operation unit 2 is also pivoted about the first pin 21 and toward the first direction M. By the two pivotal movement of the two operation units 2, the support pieces 22 do not support the end pieces 4 in the side tubes 51 which are not supported by the operation units 2, the joint 30 is released.

In addition, the pressing section 28 of each of the operation units 2 has a hook portion 29 extending toward the first direction M. When the pressing section 28 of one of the operation units 2 is pushed, but the support piece 22 of the other operation unit 2 is not disengaged from the end piece 4 of the side tube 51, the hook portion 29 of one of the operation units 2 hooks the notch 41 of the end piece 4 and drives the other operation unit 2. The support piece 22 of said the other operation unit 2 is then disengaged from the notch 41 of the other side tube 51. Therefore, the joint 30 is completely released even if only one end of the joint 30 is released. This prevents the user to fold the crib without knowing that the other end of the joint 30 is still locked and damage the joint 30.

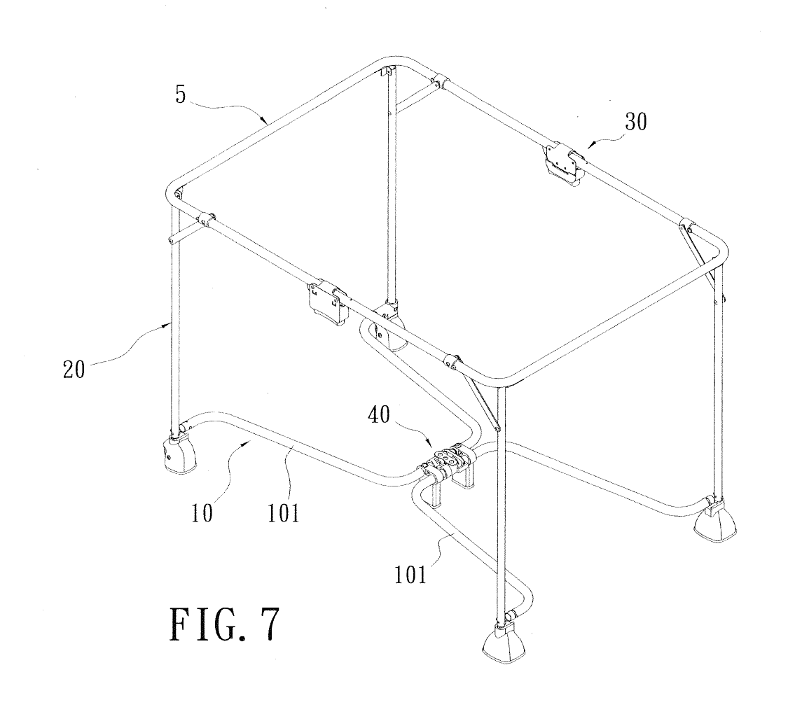

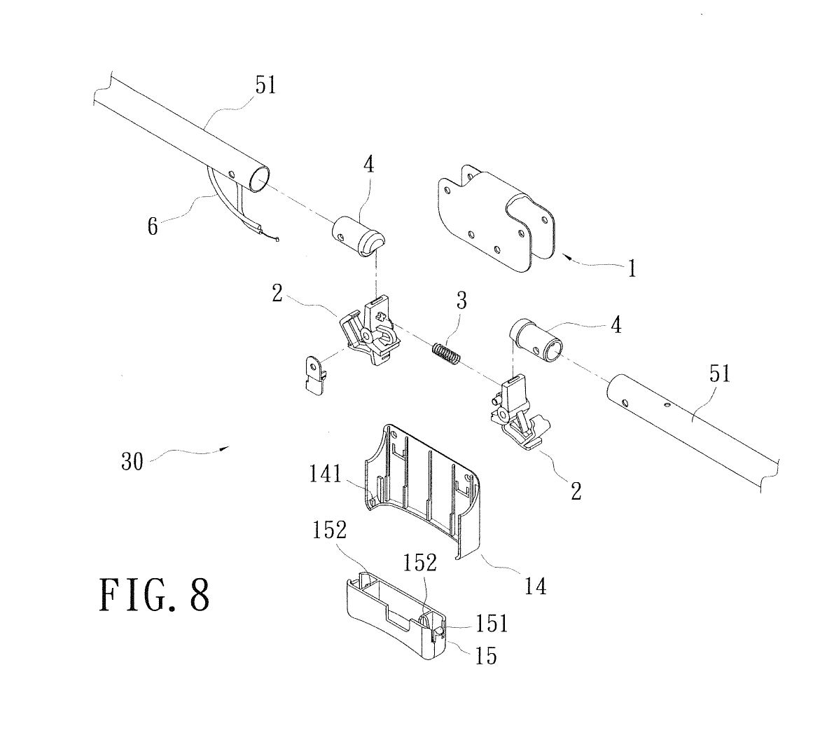

As shown in FIGS. 7 and 8, the mounting member 1 has a casing 14 mounted thereto and the casing 14 has a push member 15 extending from the underside thereof. The push member 15 has two tabs 151 on two sides thereof so as to be engaged with two protrusions 141 on an inside of the casing 14 to restrict the protruding distance. The push member 15 has two push portions 152 which are located corresponding to the pressing sections 28 of the operation units 2. When pushing the push member 15, the push portions 152 push the pressing sections 28 of the operation units 2 to fold joint 30.

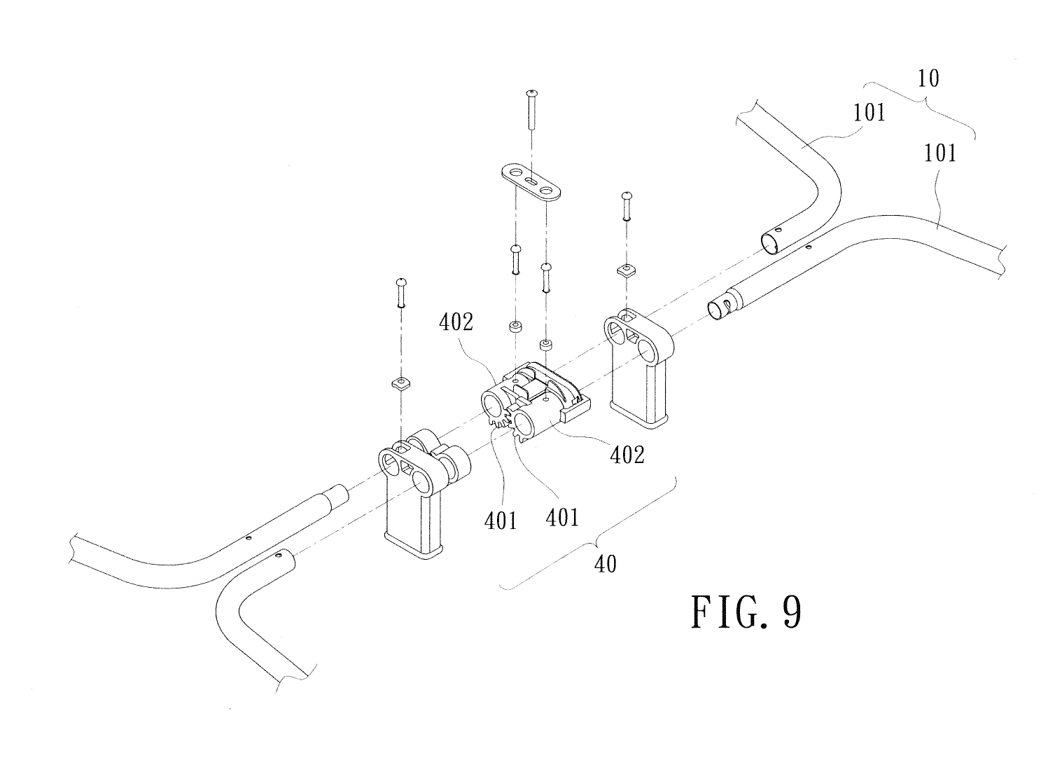

As shown in FIG. 9, the bottom base 40 of the crib has two tubular members 402 which have toothed portions 401, and the two toothed portions 401 are engaged with each other. When the crib is expanded or folded, by the engagement between the two toothed portions 401, the bottom frame 10 can be folded or expanded even only one side of the bottom frame 10 is operated.

While we have shown and described the embodiment in accordance with the present invention, it should be clear to those skilled in the art that further embodiments may be made without departing from the scope of the present invention.

What is claimed is:

1. A joint of a crib which has two joints connected to a top frame thereof, a linkage unit connected between the two joints and each of the joints connected between two side tubes of the top frame, the joint comprising:
a mounting member having a bridge and two side plates extending from two ends of the bridge, a space defined between the two side plates;
two operation units located in the space of the mounting member and each operation unit pivotably connected between the two side plates by a first pin, each operation unit having a support piece extending toward a first direction and a contact member extending toward a second direction, the support piece connected to the contact member, one of the two operation units having a pivot on a top of the contact member and the other one of the two operation units having an elongate hole defined in a top of the contact member, the pivot engaged with the elongate hole, each of the two operation units having a pressing section extending toward a third direction;
a resilient member connected between the support pieces of the two operation units;
two end pieces adapted to be respectively engaged with two respective distal ends of two side tubes of the top frame, each end piece having a notch which is located corresponding to the support piece of the operation unit corresponding thereto, a second pin extending through the side plates, the side tube and the end piece.

2. The joint as claimed in claim 1, wherein each of the support pieces has an engaging member protruding from a top thereof and each of the end pieces has a groove located beside the notch, the engaging member is engaged with the groove.

3. The joint as claimed in claim 2, wherein the linkage unit is a flexible unit.

4. The joint as claimed in claim 3, wherein the linkage unit has a first end connected to the pressing section of one of the operation units of one of the two joints, a second end of the linkage unit is connected to the pressing section of one of the operation units of the other one of the two joints.

5. The joint as claimed in claim 3, wherein the pressing section of each of the operation units has a hook portion extending toward the first direction.

6. The joint as claimed in claim 1, wherein the mounting member has a casing mounted thereto and the casing has a push member extending from an underside of the casing, the push member has two tabs on two sides thereof so as to be engaged with two protrusions on an inside of the casing, the push member has two push portions so as to push the pressing sections of the operation units.

7. A method for releasing joints of a crib, the crib having a top frame and at least two joints connected to the top frame, a linkage unit connected between the joints, when one of the joints is released, the other joint is released by the linkage unit.

8. The method as claimed in claim 7, wherein the joints each has a mounting member which has a bridge and two side plates extend from two ends of the bridge, a space is defined between the two side plates, two operation units are located in the space of the mounting member and each operation unit is pivotably connected between the two side plates by a first pin, each operation unit has a support piece extending toward a first direction and a contact member extending toward a second direction, the support piece is connected to the contact member, one of the two operation units has a pivot on a top of the contact member and the other one of the two operation units has an elongate hole defined in a top of the contact member, the pivot is engaged with the elongate hole, each of the two operation units has a pressing section extending toward a third direction, the linkage unit has a first end connected to the pressing section of one of the operation units of one of the two joints, a second end of the linkage unit is connected to the pressing section of one of the operation units of the other one of the two joints, a resilient member is connected between the support pieces of the two operation units, two end pieces respectively engaged with two respective distal ends of two side tubes of the top frame, each end piece has a notch which is located corresponding to the support piece of the operation unit corresponding thereto, a second pin extends through the side plates, the side tube and the end piece.

9. The method as claimed in claim 8, wherein each of the support pieces has an engaging member protruding from a top thereof and each of the end pieces has a groove located beside the notch, the engaging member is engaged with the groove.

10. The method as claimed in claim 9, wherein the pressing section of each of the operation units has a hook portion extending toward the first direction.

11. The method as claimed in claim 7, wherein the linkage unit is a flexible unit.

12. The method as claimed in claim 7, wherein the mounting member has a casing mounted thereto and the casing has a push member extending from an underside of the casing, the push member has two tabs on two sides thereof so as to be engaged with two protrusions on an inside of the casing, the push member has two push portions so as to push the pressing sections of the operation units.
